(19) United States
(12) Patent Application Publication
(10) Pub. No.: US 2009/0210808 A1
(43) Pub. Date: Aug. 20, 2009

(54) System and Method for Providing a Celebrity Focused Website that Integrates Personal, Entertainment, and Ecommerce Content

(75) Inventor: Elbert L. West, Gallatin, TN (US)

Correspondence Address: PILLSBURY WINTHROP SHAW PITTMAN, LLP, P.O. BOX 10500, MCLEAN, VA, 22102, US

(73) Assignee: SuiteInterface, LLC, Gallatin, TN (US)

(21) Appl. No.: 12/031,039

(22) Filed: Feb. 14, 2008

(51) Int. Cl. G06F 3/048; G06Q 30/00

(52) U.S. Cl. 715/764; 705/14

(57) ABSTRACT

The celebrity focused website may be depicted as a representation of a commercial establishment (such as a hotel) having a plurality of virtual spaces (such as hotel suites) that are occupied by one or more residents (such as a celebrity). The resident may personalize the virtual space with personal and/or ecommerce content. Personalized content may include pre-recorded responses that are relayed to the visitor in response to utterances posed by the visitor, giving the visitor a pseudo interactive experience with the resident. To encourage interesting content, the website operator may issue reward points to the resident based on internet traffic the resident attracts. By integrating personal, entertainment, and commercial aspects, the resident may leverage existing tools and infrastructure to rapidly build an online presence. Meanwhile, site visitors receive a richer, more complete, user experience. The website operator may leverage these benefits to generate revenue and expand traffic to the website.

### FIELD OF THE INVENTION

This invention relates to a system and method for providing a celebrity focused website that integrates personal, entertainment, and ecommerce content by which celebrities may effectively reach out to fans and provide the fans with a richer, more meaningful, user experience.

### BACKGROUND OF THE INVENTION

Online retail sites and social networking sites have each gained popularity. Yet despite the popularity of these sites, their existences have largely remained distinct as a result, and the number of these sites seem to have increased. It remains difficult for various entities who create their own sites to drive traffic to their sites. For example, this applies to a celebrity, an aspiring celebrity, a small retailer and other entities seeking to capture an online audience. For example, for celebrities, conventional methods of interacting with fans are so-called fan-sites, typically authored by individuals other than the celebrity. Such websites may lead to inaccurate information about the celebrity and lack personal involvement by the celebrity. Even celebrity authorized (or “official”) sites suffer various drawbacks. An example of such sites are simply web logs that occasionally provide textual information. For an aspiring celebrity, it remains difficult to be seen and heard. In part due to the large number of sites on the internet, it remains difficult for celebrities or aspiring celebrities to build a fan-base through online activity. Another problem is the cost associated with creating and/or maintaining an individual website.

These and other drawbacks exist with known online retail sites and social networking sites and other online sites.

### SUMMARY OF THE INVENTION

The invention addressing these and other drawbacks in the art relates to a system and method for providing a celebrity focused website that integrates pseudo interactive, personalized celebrity content, entertainment, ecommerce, and a rewards program. One aspect of the invention relates to a website that is presented as a representation of a commercial establishment (e.g., a hotel or other commercial establishment) having a representation of a number of virtual spaces (e.g, hotel suites or other spaces) where the virtual spaces are associated with one or more residents (e.g. a celebrity or other resident). Through various software modules associated with the website, the resident can provide, through a common user interface, a combination of functions to provide an entertaining, informative, interactive, personalized experience to visitors (e.g., visitors or other visitors) to generate visitor traffic, create an experience that causes visitors to make return visits, enable visitors to interact with the resident and with other visitors and generate revenue by including an ecommerce component, where the ecommerce component can be related to the entertainment and information content.

The website may include any combination of the following modules (and/or other modules). For example, the website may include a virtual space management module for allocating and managing virtual space among residents, an administrative module allowing website administration, a pseudo interactive content module for enabling visitors to interact with pre-recorded content from residents in what appears to be a real-time, interactive way, a media and content module for providing and managing media and content that may be accessible to virtual space visitors, a real-time interactive communication module for enabling live interaction between residents or other visitors, an ecommerce module for generating and managing virtual ecommerce spaces for selling and/or promoting goods and services, and a rewards module for issuing rewards based on web traffic.

In operation, a website operator may use the administrative module to administer the website. Administration may include setting up virtual spaces, managing login names, and/or other administrative activities. The website operator may allocate space to one or more residents in any of a variety of ways. Each resident may use the various modules to personalize its virtual space. For example, the resident may use the pseudo interactive content module to upload pre-recorded responses (e.g., audio and/or video responses) to utterances, comments and/or other utterances that a visitor may pose (in written form and/or orally) while visiting the resident's virtual space. A natural language processor may interpret the utterance to determine what it relates to, determine the prerecorded response that most closely relates to the utterance and play back that pre-recorded response. The resident may also use the media and content module to upload resident-related (or other) content that is made accessible in the virtual space. Resident-related content may include content associated with the resident (e.g., songs by the resident, music videos of the resident's songs, pictures of or related to the resident, performances by the resident, information about the resident, upcoming public appearances by the resident or any resident-related or other content). The resident may use the real time interactive communication module to enable live communication by visitors with the resident or other visitors within the virtual space of the resident. The resident may provide current information about the resident as well as personal content that the resident wishes to share with visitors. An ecommerce module may be provided to add ecommerce capabilities to the virtual space to sell and/or promote resident-related goods and/or services. A rewards module may be provided to track website traffic and reward the resident based on the level of traffic. The rewards module may reward the resident by issuing reward points to the resident based on the level of website traffic in which the resident draws. The issued reward points may be exchanged for cash and/or used to purchase goods and/or services from other residents and/or other providers associated with the website operator. The website operator may generate additional revenue by charging a surcharge, for example, for exchanging the issued reward points for cash and/or using the reward points for purchasing goods and/or services from other residents and/or other providers associated with the website operator.

Once the virtual spaces are created and made accessible, visitors can access the resident's virtual space. In operation, a visitor may use the pseudo interactive content module to pose one or more utterances while visiting the resident's virtual space. In response, the website may interpret and associate the one or more utterances with a pre-recorded response and present the user the pre-recorded response. The visitor may also use the media and content module to interact with resident related (and/or other) content that has been made accessible in the resident's virtual space. For example, the visitor may listen to a song by the resident, watch a music video for a song by the resident, watch a video clip of a recent concert, and/or other performance by the resident and/or access other media or content. The visitor may also use the real time interactive communication module to interact with the resident and/or other visitors in real time. Interactions may include, for example, sending voice, text, graphical, and/or other messages to provide a resident-related and/or other social-networking component to the site. The ecommerce module may enable a visitor to purchase, through the website, resident related goods and/or services. For example the website may present (e.g., via the media and content module) an indicator that certain resident related goods and/or services (songs, videos, event tickets, branded apparel and/or other goods or services) are available for purchase. Upon receipt of an indication by a visitor of a desire to make a purchase, the ecommerce module may be used to facilitate the purchase. Through the social networking module, visitors may also make resident-related (and/or other) goods and services available (e.g., for purchase, auction or otherwise).

By using the combination of these features, all of the participants receive benefits. For example, the website operator may generate revenue by charging a fee for the virtual spaces, advertising, a percentage of revenue received based on ecommerce conducted on or via the website, and/or other benefits. The visitors obtain a richer, more personalized and interactive experience in connection with the resident and an opportunity to connect with other visitors who share a common interest (e.g., are fans of the resident). The residents obtain many benefits including the ability to easily and inexpensively use the existing infrastructure and tools of the website operator to create an online presence, efficiently leverage the existing visitors of the website operator and/or other residents of the virtual spaces to drive traffic to the resident's virtual space, provide the perception of a personalized, interactive experience for visitors (e.g., fans) without having to be personally available on a regular basis, enable visitors (e.g, fans) to interact with one another to share information and otherwise communicate to build a social network around the resident and generate revenue through the ecommerce module, and/or receive rewards for drawing website traffic.

To enhance the personal experience, the website may provide a media and entertainment virtual space wherein the visitor may view, listen to, and/or otherwise interact with multimedia content. For example, the media and entertainment virtual space may provide a virtual radio station, wherein a visitor may listen to one of a plurality of songs. The radio playlist may include songs uploaded by a resident, for example, to help increase exposure to the resident's songs. The media and entertainment virtual space may stream content while the visitor is visiting the website. For example, the radio station may play music to the visitor while the visitor is visiting a personal virtual space.

To further enhance the personal experience, the website may provide a pseudo interactive service, wherein a resident may pre-record answers to a set of utterances. The visitor may then request answers to those utterances and receive the answer, simulating a live interview. The resident may be an aspiring singer, for example, wherein the visitor would like more information about the singer before purchasing the resident's album from the commercial and retail virtual space.

In one implementation, the website may provide a real time interactive communication service, wherein any user may interact with an online messaging service. Interactions may include, for example, creating, maintaining, editing, chatting, and/or any other interactions.

To encourage novel and interesting content, the website may reward residents with reward points based on the level of traffic that the resident generates. For example, increased web hits to the resident's site may result in an award of reward points. Reward points may be spent by the resident in any manner, including, for example, exchange for cash payment, credit any bills due to the website for site use, pay for goods and/or services rendered by other residents, and/or any other manner of spending.

In one implementation, the website may be implemented as a virtual hotel comprising a plurality of virtual spaces. For example, the virtual space may be represented by an interface retail center adjoining, or part of, the virtual hotel. The interface retail center may comprise virtual “storefronts.” Each virtual store is a personal virtual space tailored by “shop-owners,” who are the residents. Shop-owners may be any user, including celebrities promoting products, wishing to provide goods and/or services through the interface retail center.

In one implementation, the virtual space may be a collection of virtual personal spaces represented by virtual “suites” within the virtual hotel, wherein residents may personalize and create each virtual suite. Residents may design the virtual suite with virtual objects, for example, that represent particular characteristics about the resident. For example, a resident may be a celebrity promoting a particular product. A virtual representation of the particular product may be placed in the virtual suite, whereupon clicking or otherwise selecting the representation reveals additional information about the particular product such as, for example, an advertisement, product specifications, and/or any other additional information. Selection of the product may indicate that it is for sale in a virtual store maintained by the celebrity at the interface retail center. Furthermore, the resident may include a virtual object resembling a diary, the selection of which may access the real time interactive communication entries of the resident. The resident may also include a virtual interview chair, the selection of which may activate a pseudo interactive session with the resident. The resident may also include a virtual television playing multi-media content uploaded to the multimedia and entertainment area. Such content may include content related to the resident such as, for example, music videos of the resident who is a singer, sports replays of the resident who is a sports star, sample clips of the resident giving a motivational lecture, and/or any other content. Other virtual objects are contemplated.

A visitor may register with the website to gain access. The visitor may visit the media and entertainment area where the user may listen to a plurality of music, including one or more songs from the resident. The visitor may peruse the interface retail center. While shopping, the media and entertainment module may stream one or more songs of the resident to the visitor. While shopping at the interface retail center or visiting the media and entertainment area, for example, the visitor may retrieve more information regarding the resident. The visitor may elect to view the real time interactive communication entries of the resident, enter the virtual space of the resident, go to the virtual storefront of the resident to purchase music, interview the resident and/or access any other content regarding the resident. According to this aspect of the invention, a visitor may get a more complete user experience while residents may gain broader exposure to a larger audience in a more meaningful, organized manner.

Various other objects, features, and advantages of the invention will be apparent through the detailed description and the drawings attached hereto. It is also to be understood that both the foregoing general description and the following detailed description are exemplary and not restrictive of the scope of the invention.

### BRIEF DESCRIPTION OF THE DRAWINGS

FIG. 1 is an exemplary illustration of a schematic diagram of a system, according to an aspect of the invention.

FIG. 2 is an exemplary illustration of a schematic diagram of an interface retail center module, according to an aspect of the invention.

FIG. 3 illustrates a flowchart of processing for an interview using a pseudo interactive module, according to an aspect of the invention.

FIG. 4 illustrates a flowchart of processing for an interviewee responding to an interview utterance using a pseudo interactive module, according to an aspect of the invention.

FIG. 5 illustrates a flowchart of processing for awarding and using reward points, according to an aspect of the invention.

### DETAILED DESCRIPTION OF THE INVENTION

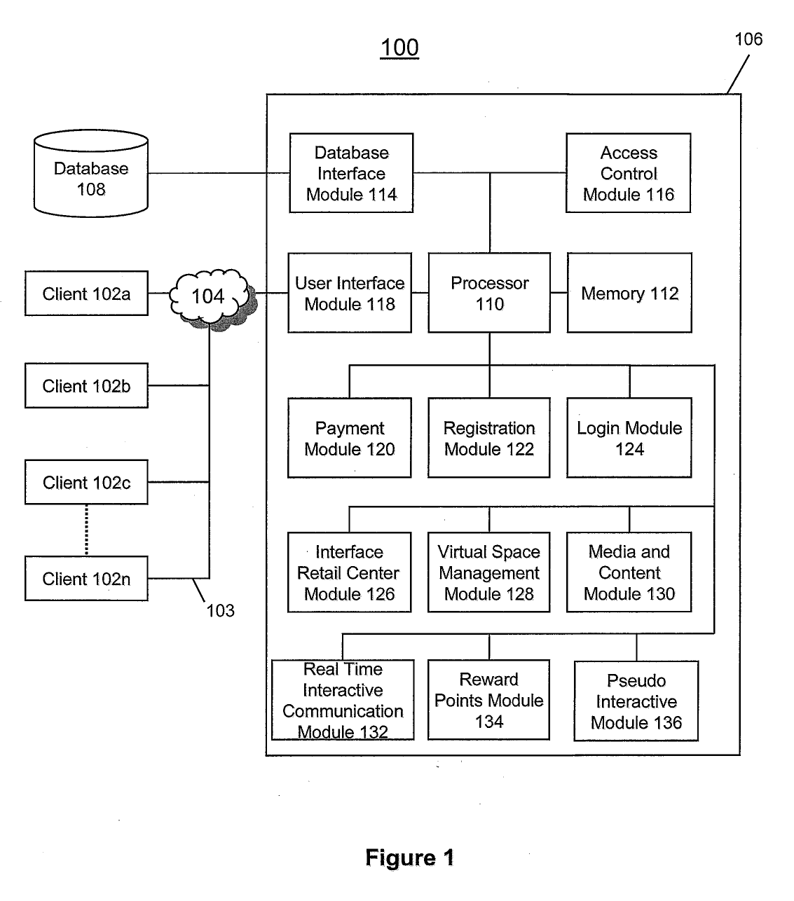

FIG. 1 is an exemplary illustration of a schematic diagram of a system 100, according to an aspect of the invention. One implementation of the invention includes at least one server 106 generating a virtual hotel. Server 106 may interface with or connect to at least one database 108. In some embodiments, system 106 may access and/or interface with database 108, which may store user account information, critical personal information, and/or other information used by the invention. Database 108 may store encrypted information and/or non-encrypted information as necessary. According to an embodiment of the invention, database 108 may be, include, or interface to, for example, an Oracle™ relational database sold commercially by Oracle Corporation. Other databases, such as Informix™, DB2 (Database 2) or other data storage or query formats, platforms, or resources such as OLAP (On Line Analytical Processing), SQL (Standard Language Query), a SAN (storage area network), Microsoft Access™ or others may also be used, incorporated, or accessed into the invention. Database 108 may include any combination of databases or other data storage devices. In some embodiments, database 108 may reside on or otherwise be associated with a computer system maintained by an entity providing access to the systems and methods of the invention. In some embodiments, information used by the systems and methods of the invention may be stored locally, for example, on a computer system of a user, or on other computer systems.

Server 106 may communicate with one or more clients (102a, 102b, 102c, . . . , 102n). By way of example, server 106 may communicate with the one or more clients over a communication path 103 via network 104. The communication path 103 may include any suitable wired and/or wireless communication path, including any one or more of, for instance, a copper telephone line, a Digital Subscriber Line (DSL) connection, a Digital Data Service (DDS) connection, an Ethernet connection, an Integrated Services Digital Network (ISDN) line, an analog modem connection, a cable modem connection, a wireless data connection, or other connection. Other configurations and system architectures may be used. Network 104 may include any one or more of, for instance, the Internet, an intranet, a PAN (Personal Area Network), a LAN (Local Area Network), a WAN (Wide Area Network), a SAN (Storage Area Network), or a MAN (Metropolitan Area Network).

In one implementation, server 106 may include at least one or more of a processor 110, a memory 112, a database interface module 114, an access control module 116, a user interface module 118, a payment module 120, a registration module 122, a login module 124, an interface retail center module 126, a virtual space management module 128, a media and entertainment module 130, a real time interactive communication module 132, a reward points module 134, a pseudo interactive module 136, and/or any other module.

Processor 110 and memory 112 may comprise any suitable components which individually are known in the art, including those described elsewhere herein. Database interface module 114 may include one or more hardware and/or software modules to access and/or interface with database 108 to perform database operations such as, for example, insert, retrieve, update, and/or perform other database operations.

Access control module 116 may include one or more hardware and/or software modules that enable different levels of access to content (or different parts of the virtual hotel) based at least in part on the user. For example, portions of the virtual hotel may be restricted to special users, such as, for example, “V.I.P.” visitors, or any other special user. The access control module may also issue “suite keys” that give access to otherwise restricted suites of residents. This aspect of the invention may be used, for example, as a way to allow the resident to limit access to their suite. Suite keys may be temporary or permanent, based at least in part on selection by the resident.

User interface module 118 may include one or more hardware and/or software modules to provide a user, such as a shop-owner, resident, visitor, and/or other user with an interface through which to select among a plurality of operating modes, and may present a graphical and/or textual interface.

Payment module 120 may include one or more hardware and/or software modules that provide the user with the ability to make and view payments, for example. Payments may include accepting and processing payments on behalf of shop owners, as discussed elsewhere herein, for example. Forms of payment may include, for example, cash, online credit card, online check, online payment services (e.g., paypal™, google checkout™), reward points (discussed herein elsewhere), and/or other forms of payment, as would be appreciated by those skilled in the art. Payment fees may be collected using options such as, for example, prepaid services, subscription services, pay-as-you-go, and/or any other payment options.

Registration module 122 may include one or more hardware and/or software modules to provide the user with forms in which the user may register to use the system. Any form input method as would be appreciated by those skilled in the art may be used, including, for example, Hypertext Markup Language form input.

Login module 124 may include one or more hardware and/or software modules that may authenticate the user and grant access to the virtual hotel. Authentication may use any method of authentication such as, for example, shared secret, biometric identification, hardware identification (such as an electronic certificate on a Universal Serial Bus), and/or any other method of authentication.

Interface retail center module 126 may include one or more hardware and/or software modules to provide a virtual retail center, wherein residents may lease virtual storefronts to conduct business such as sell, market, advertise, and/or conduct any other business. The interface retail center may be presented in three-dimensions (e.g., graphically simulating an actual retail center), in two-dimensions (e.g., graphically providing icons), textually (e.g., presenting lists of storefronts), and/or any other presentation method.

Virtual space management module 128 may include one or more hardware and/or software modules, wherein the resident may build and customize a virtual suite for commercial, social, and/or other reasons. Upon entering the virtual suite, the visitor may be greeted by a resident's pre-recorded message welcoming the visitor. Representations of one or more objects in the virtual suite, for example, may be selectable by the visitor to reveal more information related to that object.

For example, the resident may be a celebrity wishing to increase exposure to fans, both commercially and/or socially. For example, the resident may endorse a product by placing a virtual representation of that product in the virtual suite, whereupon clicking the product may result in an action such as take the visitor to an advertisement, show an endorsement by the resident, forward to a website for the product, and/or any other action. In another example, the resident may place objects representing actual objects for sale in the interface retail center (or other retail setting) created or endorsed by the resident. Such objects may include, for example, autographed items, products bearing the resident's name, and/or any other object. Yet another example may be a virtual jukebox object, wherein clicking or otherwise selecting the jukebox causes a selection of music in which the resident uploaded. The selection of music may be any music such as, for example, music performed by the resident and available for sale, music in which the resident prefers, and/or any other music. The musical selections may be categorized by music type.

To reach out to fans socially, for example, the resident may add a representation of a newspaper (or other virtual object) to the virtual suite, whereupon clicking or otherwise selecting the newspaper by the user may reveal the latest news regarding the resident. An object representing a calendar, for example, may be included in the virtual suite, the selection of which may show a listing of public appearances scheduled for the resident. Additionally, a virtual object representing stationary may be included, wherein selecting the stationary may enable the visitor to leave a message for the resident. The message may be delivered using any means such as, for example, an email message, a real time interactive communication entry, and/or any other means. An object representing an interview chair, for example, may also be included, wherein clicking or otherwise selecting the object may initiate a simulated interview with the resident via the “pseudo interactive” module, as discussed elsewhere herein. A virtual television, for example, may be added to the virtual suite, wherein the resident may include video and/or audio content. For example, the resident may be a singer giving vocal lessons on video, a sports athlete giving advice on game-play, an actor showing video of behind-the-scenes moments, and/or any other content. Furthermore, the resident may reach out to fans by including real time interactive communication entries, accessible in the virtual suite by selecting a virtual object representing a diary, for example. In still another example, the resident may include an object representing a recipe book, the selection of which may reveal dining preferences such as favorite recipes, foods, restaurants, and/or other dining preferences of the resident. The foregoing virtual objects are exemplary only and are not limiting. For example, pre-selected virtual objects (such as a generic representation of a newspaper or television) may be made available to the resident for inclusion into the virtual suite or the resident may upload virtual objects. Furthermore, virtual objects may be used for any purpose, whether to promote retail goods and/or services or to socially interact with visitors.

The virtual suite may be occupied by any resident. For example, the resident may be a fictitious character such as a cartoon, comic book, and/or any other fictitious character. The fictitious character may be a children's cartoon character, for example, that may give child fans an interactive experience with the cartoon character. The cartoon character may include objects that provide an interactive learning experience that is otherwise unavailable on traditional programming. Producers of the cartoon character may create the virtual suite to maximize exposure of the cartoon character, provide a more meaningful interaction with children, and/or provide a medium in which parents may purchase goods and/or services related to the cartoon character.

In yet another example, a resident may use the virtual suite to meet others, socialize, network, and/or do any other activity. As a further example, the resident may add personal objects within the virtual suite to share personal information such as, for example, a picture of a landmark, wherein clicking or otherwise selecting the picture may reveal a photo-album of the resident's trip to the landmark. Clicking or otherwise selecting the picture may also include narratives, provided by the resident for example, in multimedia and/or textual format. Using this aspect of the invention enables the resident to socially network, for example, in a more in-depth and personal manner.

Media and entertainment module 130 may include one or more hardware and/or software modules that provide the visitor with multi-media entertainment such as, for example, audio, video, games, and/or other multi-media entertainment. Content may be delivered based at least in part on selection by the user, playlists in which known artists and unknown artists (e.g., residents using the virtual hotel to get exposure) may be rotated, community ratings, and/or any other basis for selection. The media and entertainment module 130 may supply streaming music, for example, to the visitor while the visitor peruses through the virtual interface retail center, visits suites, and/or otherwise interacts with the virtual hotel. Media and entertainment module 130 may then give the visitor an option to visit a resident's suite upon hearing the resident's song, for example. Media and entertainment module 130 may also provide any user (such as a resident, visitor, shop-owner, and/or any other user of the website) with the ability to upload multi-media content for access by other users. Content may include video, audio, gaming, and/or other multi-media content.

Real time interactive communication module 132 may include one or more hardware and/or software modules that enables the user to interact with one or more web logs (“blogs”). The user may maintain their own blog in addition to interacting with other blogs. The blogs may be accessed from a plurality of sources including, for example, links from the virtual suite of a resident, links from the interface retail center (e.g., presentation of a link to the blog of a resident while the user listens to a song of the resident), and/or any other source.

Reward points module 134 may include one or more hardware and/or software modules that may manage reward points. Reward points may be awarded to a resident based at least in part on the amount of internet traffic that the resident attracts. For example, increased traffic brought in by the virtual suite of the resident may result in increased reward points that the resident accrues. Internet traffic may be measured using any technique such as, for example, unique visitors, total number of hits, and/or any other technique, which are well known in the art. Reward points may be correlated to a monetary value. For example, four points may correlate to one dollar. The correlated monetary value may be used at participating shop-owners in the interface retail center, and/or any other participating retailer and/or service provider. The reward points may also be used to pay any fees due to the system such as, for example, lease payments for virtual storefronts and shops, fees due to rent suites, and/or any other fees. Reward points may expire, wherein the reward points must be used within an expiration period (e.g., within one year of being issued the reward points). During any period, including at the end of the expiration period, the resident may elect to receive actual cash in lieu of the reward points. The actual cash value of reward points may be less than the value of the reward points when used to purchase goods and/or services from participating retailers and/or service providers. For example, four points may correlate to one dollar to purchase goods and/or services. However, four points may correlate to a half dollar actual cash value. Reward points may be graduated such that after certain levels of monitored traffic, more reward points are rewarded. For example, the first 100,000 visitors may correspond to one traffic point per visitor whereas from 100,000 to 200,000 two traffic points may be awarded per visitor. Thus, in the preceding example, if a content provider generated 150,000 visitors then 200,000 traffic points may be awarded. Any combination of graduated rewards as would be appreciated by those skilled in the art are contemplated. Furthermore, bonus reward points may be awarded based on milestone traffic generated. For example, a content provider may be awarded 500,000 traffic points for generating 250,000 visitors. The foregoing examples are exemplary only and should not be viewed as limiting.

Pseudo interactive module 136 may include one or more hardware and/or software modules that accepts pre-recorded content in which any user responds to utterances posed by another user. Content may be recorded by the responding user using any multimedia format, such as audio, video, or other multimedia format. Utterances may include, for example, commonly asked utterances, utterances the responding user would like to answer, and/or any other utterance. Pseudo interactive module 136 may take utterances using any form of input, including, for example, text-based input (the user typing an utterance), voice-recognition (the user asking an utterance into a microphone, camera, or other input device), the user selecting among a list of utterances that are available, and/or any other form of input.

If pseudo interactive module 136 does not understand or recognize an utterance, pseudo interactive module 136 may compare the unrecognized utterance with a list of utterances that are available and present the user posing utterances a list of suggestions based on the comparison. A comparison may include any word comparison method such as, for example, checking commonly misspelled words, comparing words of sentences out of sequence, grammatical checking, ignoring inconsequential words, and/or any other comparison method. If the utterance is not understood or recognized, pseudo interactive module 136 may also inform the user posing utterances and store the utterance for presentation to the resident. The resident and/or website may provide a response to the utterance by answering, ignoring, deny answering, and/or provide any other response to the utterance. The responding user may be, for example, a resident of the virtual suite. The user posing utterances may be, for example, a visitor visiting the virtual suite of the virtual suite. Using this aspect of the invention, the user posing utterances may perceive that an actual interview is taking place.

Pseudo interactive module 136 may enable the news media access to interview content. For example, a resident may wish to enter statements about a public incident using pseudo interactive module 136. Media outlets may access this content, minimizing inaccurate reporting, for example. It should be understood that any user may participate in the interview using pseudo interactive module 136 and interviews may be conducted in association with a virtual suite, the virtual hotel, independently outside the virtual hotel, and/or in any other context. For example, pseudo interactive module 136 may be used for social meeting, gathering networking, and/or any other purpose. As a further example, pseudo interactive module 136 may provide users with the ability to interview prospective dates.

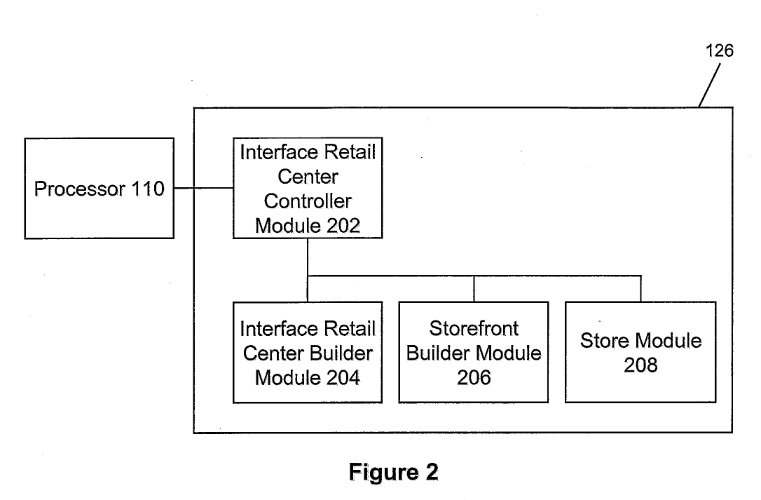

FIG. 2 is an exemplary illustration of a schematic diagram of interface retail center module 126, according to an aspect of the invention. Interface retail center module 126 may include one or more hardware and/or software modules such as, for example, interface retail center controller module 202, interface retail center builder module 204, storefront builder module 206, store module 208, and/or any other module. Interface retail center controller module 202 may be controlled by and access other modules through processor 110. Interface retail center controller module 202 may also control at least one module that is part of interface retail center module 126. Interface retail center builder module 204 may render the virtual interface retail center in three-dimensions (e.g., graphically simulating an actual interface retail center), in two-dimensions (e.g., graphically providing icons), textually (e.g., presenting lists of storefronts), and/or any other presentation method. Storefront builder module 206 may include one or more hardware and/or software modules to provide shop-owners with the ability to build and customize their storefronts. For example, storefront builder module 206 may provide functions to place design elements on the storefront. Design elements may include, for example, signs, company logos, graphics, and/or any other design elements. Store module 208 may include one or more hardware and/or software modules that provide shop-owners with the ability to customize a virtual shop such as, for example, offer advertising, provide links to offsite shopping, sell goods and/or services from the virtual shop, and/or other customizations. Goods may include, for example, music downloads, retail goods, and/or any other goods. Services may include, for example, web programming services, contracting services, and/or any other services. Store module 208 may also interface with payment module 120 to accept payment from the user for goods and/or services purchased.

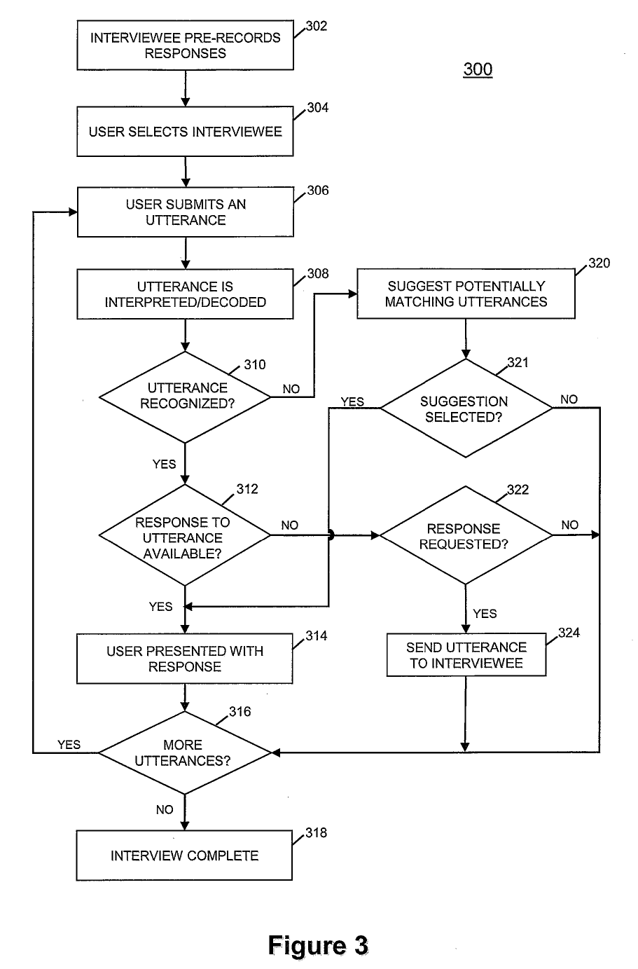

FIG. 3 illustrates a flowchart of a process 300 for an interview using a pseudo interactive module, according to an aspect of the invention. The described operations may be accomplished using some or all of the system components described in detail above and, in some implementations, various operations may be performed in different sequences. In other implementations, additional operations may be performed along with some or all of the operations shown in FIG. 3. In yet other implementations, one or more operations may be performed simultaneously. Accordingly, the operations described are exemplary in nature and, as such, should not be viewed as limiting.

In an operation 302, an interviewee may pre-record answers to utterances using any medium such as audio, video, and/or any other medium. Utterances may be based on frequently posed utterances, utterances the interviewer would like to address, and/or any other utterances. The answers may be coupled to utterances, uploaded, and made available to interviewers. In an operation 304, an interviewer may be presented with and select from a list of interviewees that have uploaded answers to utterances. In an operation 306, the interviewer may pose an utterance using any input device such as, for example, a keyboard, a microphone, a webcam, and/or any other input device. In an operation 308, the utterance may be interpreted and/or decoded. Interpreting the utterance may include, for example, parsing text entries from a keyboard input, speech recognition, and/or any other interpreting method based at least in part on the input device used to pose the utterance.

If in an operation 310 the utterance is recognized by being properly interpreted and/or decoded, process 300 may proceed to an operation 312, wherein the utterance is compared to utterances in which answers have been pre-recorded or otherwise have a response. Operation 312 may include resolving minor wording variations between the utterance posed and the utterance in which an answer or response is available. For example, “what is your favorite color?” may be resolved to be equivalent to “what color do you like the best?” If in operation 312, an answer or response is available, then process 300 may proceed to an operation 314, wherein the answer or response is presented to the interviewer. Process 300 may then proceed to an operation 316, wherein if the interviewer has no more utterances, then processing may proceed to an operation 318, wherein the interview is completed. Returning to operation 316, if the interviewer has more utterances, then processing may return to operation 306, wherein the interviewer poses an utterance.

Returning to operation 310, if the utterance was not recognized or properly interpreted in operation 308, the utterance was not understood by the system and process 300 may proceed to an operation 320, wherein the interviewer is notified that the utterance was not understood and is given possible utterances that are suggested to match the interviewer's utterance. Processing may proceed to an operation 321, wherein if a suggested utterance is selected, then processing may proceed to an operation 314 where the interviewer is presented with the response. Returning to operation 321, if the suggested utterance is not selected, then the utterance is misunderstood and the interviewer may be prompted to pose another utterance in an operation 316, wherein if the interviewer elects to try posing the utterance again or pose another utterance then processing may return to operation 306. If in operation 316 the user elects not to try again or pose another utterance, processing may proceed to operation 318, wherein the interview may be completed.

Returning to operation 312, if a response to the utterance is not available, then process 300 may proceed to an operation 322, wherein the interviewer is given the option to request a response from the interviewee. If in operation 322, the interviewer requests a response, then processing may proceed to an operation 324, wherein the interviewee is notified of the unanswered utterance. Notification may include any method such as, for example, email, storage in a database of requested utterances, and/or any other method. Once the utterance is forwarded to the interviewee, process 300 may proceed operation 316, wherein the interviewer may elect to pose more utterances. Returning to operation 322, if a response to the utterance is not requested by the user, then processing may proceed to operation 316, wherein the interviewer may elect to pose more utterances.

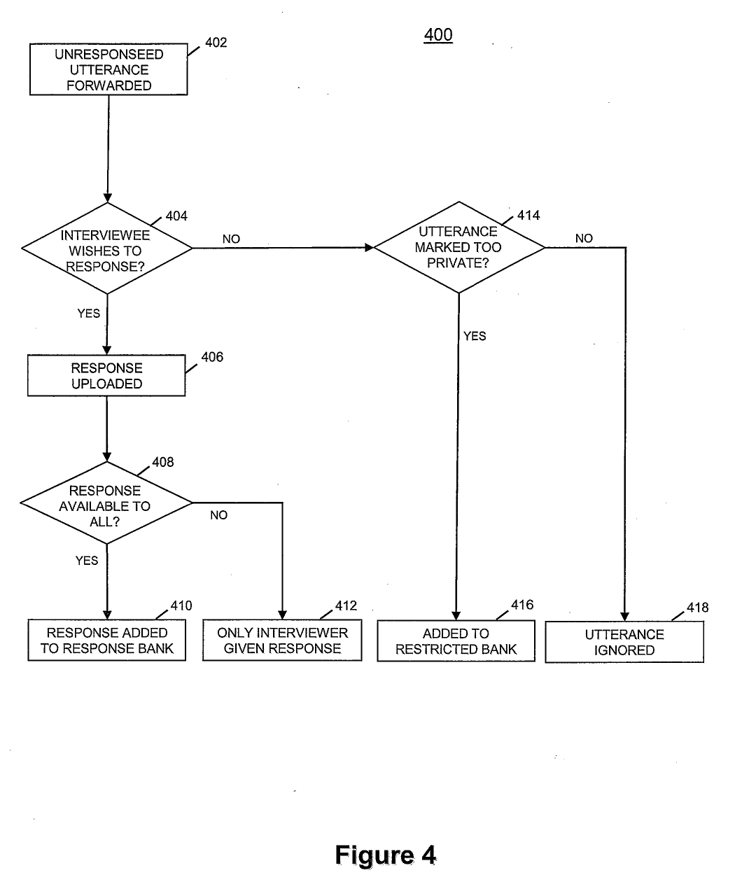

FIG. 4 illustrates a flowchart of process 400 for an interviewee responding to an interview utterance using a pseudo interactive module 224, according to an aspect of the invention. The described operations may be accomplished using some or all of the system components described in detail above and, in some implementations, various operations may be performed in different sequences. In other implementations, additional operations may be performed along with some or all of the operations shown in FIG. 4. In yet other implementations, one or more operations may be performed simultaneously. Accordingly, the operations described are exemplary in nature and, as such, should not be viewed as limiting.

In an operation 402, an unanswered interview utterance may be forwarded to the interviewee. If in an operation 404 the interviewee wishes to respond, then process 400 may proceed to an operation 406, wherein the interviewee records a response using any medium and uploads the response using the pseudo interactive module 224. Processing may proceed to an operation 408, wherein if the interviewee elects to make the answer available to other interviewers that pose the same utterance, then processing may proceed to an operation 410. In operation 410, the response is made available to other interviewers by adding the utterance and answer to the database. Returning to operation 408, if the interviewee does not elect to make the response available to other interviewers, then processing may proceed to an operation 412, wherein only the interviewer that posed the utterance is presented with the response, The response may be presented to the interviewer using any method including, for example, email, link to a secured site, and/or any other method.

Returning to operation 404, if the interviewee does not elect to respond to the utterance, then processing may proceed to an operation 414, wherein if the interviewee marked the utterance as too private, then processing may proceed to an operation 416. In operation 416, the utterance is added to a database of restricted utterances such that other interviewers that pose the same or similar utterance may be forwarded a response indicating that the interviewee believes that the utterance is too private to respond. In operation 416, the interviewer may be notified of the private indication.

Returning to operation 414, if the interviewee has not marked the utterance too private, then processing may proceed to an operation 418, wherein the utterance is ignored. In operation 418, the interviewee may be notified that the interviewee did not respond to the utterance.

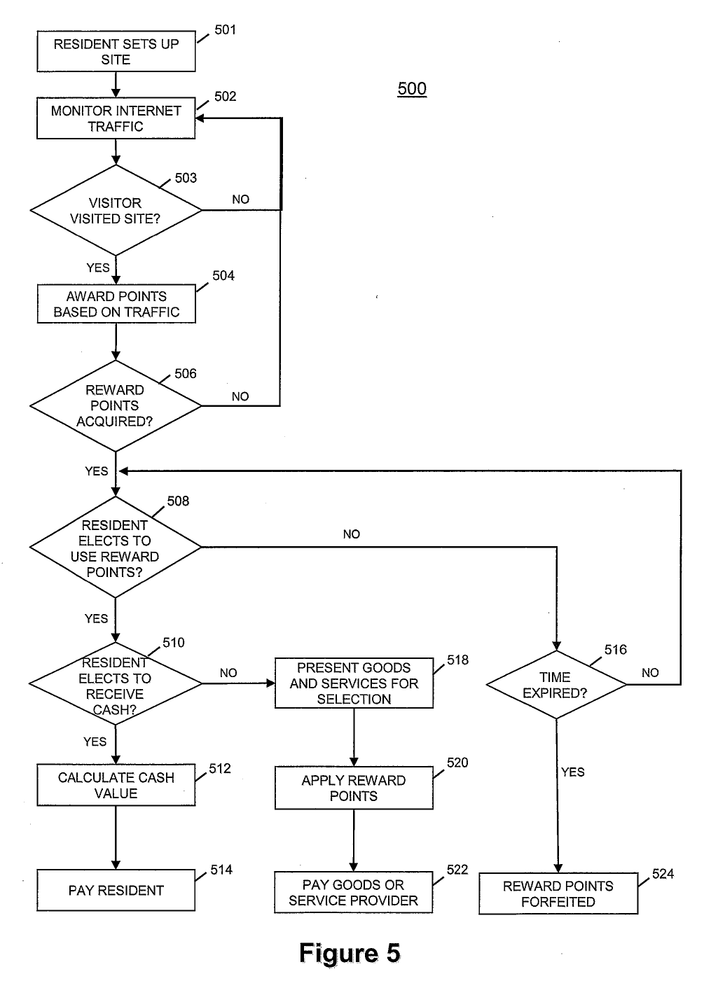

FIG. 5 illustrates a flowchart of process 500 for awarding and using reward points, according to an aspect of the invention. The described operations may be accomplished using some or all of the system components described in detail above and, in some implementations, various operations may be performed in different sequences. In other implementations, additional operations may be performed along with some or all of the operations shown in FIG. 5. In yet other implementations, one or more operations may be performed simultaneously. Accordingly, the operations described are exemplary in nature and, as such, should not be viewed as limiting.

In an operation 501, a resident may set up a site such as a virtual suite in the virtual hotel. In an operation 502, internet traffic to the site is monitored using means well known in the art. If in an operation 503, a visitor has visited the site, then processing may proceed to an operation 504, wherein internet traffic to the site may be monitored. Based at least in part on the internet traffic, reward points may be awarded to the resident. If in an operation 506, reward points have been accrued by the resident, process 500 may proceed to an operation 508, wherein if the resident elects to use the reward points, then processing may proceed to an operation 510.

In operation 510, if the resident elects to receive a cash payment in lieu of the reward points, then processing may proceed to an operation 512, wherein the cash value of the accrued reward points is calculated. Upon calculation, process 500 may proceed to an operation 514, wherein the resident is paid. Payment to the resident may be made using any payment method, including, for example, online payment services, credit card refund, deduction from any fees due to the website operator by the resident, check, and/or any other payment method.

Returning to operation 503, if no visitors have visited the site, processing may return to operation 502, wherein internet traffic is monitored.

Returning to operation 506, if no reward points have been accrued, then process 500 may return to operation 502, wherein internet traffic to the site is monitored. It should be noted, however, internet traffic may be monitored continuously throughout the process.

Returning to operation 508, if the resident does not elect to use the reward points, then process 500 may proceed to an operation 516, wherein if the time period to use the reward points have expired, then processing may proceed to an operation 524, wherein reward points are forfeited.

Returning to operation 510, if the resident does not elect to receive cash, then the resident may be presented with goods and services for which the reward points may be used in an operation 518. In operation 518, the resident selects the goods and/or services to which the reward points are to be applied and processing may proceed to an operation 520, wherein the reward points are applied and the goods and/or services are rendered to the resident. In operation 520, the applied reward points may be converted to a dollar value amount to be paid to the provider of the goods and/or services. Process 500 may then proceed to an operation 522, wherein the provider of the goods and/or service are paid. Payments to the provider may be made using any payment method as discussed elsewhere herein. Returning to operation 516, if time has not expired, then processing may return to operation 508.

Although illustrated herein as a virtual hotel having virtual suites, the invention may depict the website as any other virtual representation including a building, object, and/or other space.

Other implementations, uses and advantages of the invention will be apparent to those skilled in the art from consideration of the specification and practice of the invention disclosed herein. The specification should be considered exemplary only.

What is claimed is:

1. A method for providing a website infrastructure that enhances the web presence of a plurality of content providers, comprising:
receiving first web content from a first content provider, wherein the first web content comprises personal content;
receiving second web content from a second content provider, wherein the second web content comprises commercial content;
populating a first one of a plurality of virtual spaces using the first web content;
populating a second one of the plurality of virtual spaces using the second web content;
generating at least one website depicting a commercial establishment, wherein the depiction of the commercial establishment comprises the plurality of virtual spaces; and
providing the generated at least one website to a user.

2. The method of claim 1, wherein the depicted commercial establishment is a virtual hotel.

3. The method of claim 2, wherein at least one of the plurality of virtual spaces are depicted as virtual suites within the virtual hotel.

4. The method of claim 2, wherein at least one of the plurality of virtual spaces are depicted as virtual stores within the virtual hotel.

5. The method of claim 1, further comprising:
receiving from the first content provider one or more virtual objects;
presenting the one or more virtual objects as part of the first one of the plurality of virtual spaces;
receiving a selection, by the user, of the one or more virtual objects;
executing an action based on the selection of the one or more virtual objects; and
providing the results of the executed action to the user.

6. The method of claim 5, further comprising:
in response to the selection of the one or more virtual objects:
initiating a pseudo interactive session between the first content provider and the user;
receiving one or more utterances posed by the user;
identifying at least one known utterance corresponding to the received one or more utterances;
identifying a pre-recorded response based on the identified at least one known utterance; and
providing the user with the pre-recorded response.

7. The method of claim 1, further comprising:
monitoring first web traffic generated by the first one of the plurality of virtual spaces; and
rewarding the first content provider with traffic points based on the monitored first web traffic;

8. The method of claim 1, wherein the first content provider and the second content provider is the same content provider.

9. The method of claim 1, wherein the first one of the plurality of virtual spaces is the same virtual space as the second one of the plurality of virtual spaces.

10. A method for rewarding, by a website operator, web traffic accrued by a website using web content received from a content provider, comprising:
providing an area controlled by the website operator in which to generate the website;
receiving web content;
generating the website based on the received web content;
monitoring web traffic drawn to the generated website;
calculating traffic points based at least in part on the monitored web traffic; and
providing the calculated traffic points to the content provider.

11. The method of claim 10, wherein the traffic points may be redeemed for cash.

12. The method of claim 10, wherein the traffic points may be redeemed to purchase goods or services from one or more providers associated with the website operator.

13. The method of claim 10, wherein the traffic points may expire if not redeemed within an expiration period.

14. The method of claim 10, wherein calculating traffic points is graduated such that award of traffic points is enhanced based on the level of web traffic drawn by the website.

15. The method of claim 10, wherein one or more bonus traffic points are awarded based on milestone web traffic drawn.

16. A method for conducting a pseudo interactive session between a first user and a second user, comprising:
receiving from the first user one or more pre-recorded response to one or more known utterances;
receiving from the second user one or more posed utterances;
processing the received one or more posed utterances;
identifying at least one of the one or more known utterances corresponding to the processed one or more utterances;
identifying at least one of the one or more pre-recorded responses based on the identified at least one the one or more know utterances; and
providing the second user with the identified at least one of the one or more pre-recorded responses.

17. The method of claim 16, wherein the identified at least one of the one or more pre-recorded responses indicates that the first user does not wish to respond to the one or more posed utterances.

18. A system for providing a website infrastructure that enhances the web presence of a plurality of content providers, the system comprising one or more processing devices collectively operable to:
receive first web content from a first content provider, wherein the first web content comprises personal content;
receive second web content from a second content provider, wherein the second web content comprises commercial content;
populate a first one of a plurality of virtual spaces using the first web content;
populate a second one of the plurality of virtual spaces using the second web content;
generate at least one website depicting a commercial establishment, wherein the depiction of the commercial establishment comprises the plurality of virtual spaces; and
provide the generated at least one website to a user.

19. The system of claim 18, wherein the depicted commercial establishment is a virtual hotel.

20. The system of claim 19, wherein at least one of the plurality of virtual spaces are depicted as virtual suites within the virtual hotel.

21. The system of claim 19, wherein at least one of the plurality of virtual spaces are depicted as virtual stores within the virtual hotel.

22. The system of claim 18, further operable to:
receive from the first content provider one or more virtual objects;
present the one or more virtual objects as part of the first one of the plurality of virtual spaces;
receive a selection, by the user, of the one or more virtual objects;
execute an action based on the selection of the one or more virtual objects; and
provide the results of the executed action to the user.

23. The system of claim 22, further operable to:
in response to the selection of the one or more virtual objects:
initiate a pseudo interactive session between the first content provider and the user;
receive one or more utterances posed by the user;
identify at least one known utterance corresponding to the received one or more utterances;
identify a pre-recorded response based on the identified at least one known utterance; and
provide the user with the pre-recorded response.

24. The system of claim 18, further operable to:
monitor first web traffic generated by the first one of the plurality of virtual spaces; and
reward the first content provider with traffic points based on the monitored first web traffic;

25. The system of claim 18, wherein the first content provider and the second content provider is the same content provider.

26. The system of claim 18, wherein the first one of the plurality of virtual spaces is the same virtual space as the second one of the plurality of virtual spaces.

27. A system for rewarding, by a website operator, web traffic accrued by a website using web content received from a content provider, the system comprising one or more processing devices collectively operable to:
provide an area controlled by the website operator in which to generate the website;
receive web content;
generate the website based on the received web content;
monitor web traffic drawn to the generated website;
calculate traffic points based at least in part on the monitored web traffic; and
provide the calculated traffic points to the content provider.

28. The system of claim 27, wherein the traffic points may be redeemed for cash.

29. The method of claim 27, wherein the traffic points may be redeemed to purchase goods or services from one or more providers associated with the website operator.

30. The system of claim 27, wherein the traffic points may expire if not redeemed within an expiration period.

31. The system of claim 27, wherein calculating traffic points is graduated such that award of traffic points is enhanced based on the level of web traffic drawn by the website.

32. The system of claim 27, wherein one or more bonus traffic points are awarded based on milestone web traffic drawn.

33. A system for conducting a pseudo interactive session between a first user and a second user, the system comprising one or more processing devices collectively operable to:
receive from the first user one or more pre-recorded response to one or more known utterances;
receive from the second user one or more posed utterances;
process the received one or more posed utterances;
identify at least one of the one or more known utterances corresponding to the processed one or more utterances;
identify at least one of the one or more pre-recorded responses based on the identified at least one the one or more know utterances; and
provide the second user with the identified at least one of the one or more pre-recorded responses.

34. The system of claim 33, wherein the identified at least one of the one or more pre-recorded responses indicates that the first user does not wish to respond to the one or more posed utterances.
